(19) United States
(12) Patent Application Publication
(10) Pub. No.: US 2012/0097668 A1
(43) Pub. Date: Apr. 26, 2012

(54) APPARATUS AND SYSTEM FOR COOKING RIBBED TORTILLA BOWLS IN A MICROWAVE

(76) Inventors: Eugene T. McGuiness, Oceanside, CA (US); Morgan McGuiness, La Palma, CA (US)

(21) Appl. No.: 13/236,113

(22) Filed: Sep. 19, 2011

Related U.S. Application Data
(60) Provisional application No. 61/403,752, filed on Sep. 20, 2010.

(51) Int. Cl. H05B 6/80

(52) U.S. Cl. 219/725

(57) ABSTRACT

A device for cooking tortilla shells or other foods evenly to create bowls shaped for salads and the like. A two-piece cooking apparatus has two similarly configured rounded shaping members each with a flat top and a downward extending side wall. The top and side walls have a plurality of apertures. A tortilla, flatbread or potato is placed in between the two shaping members and heated in a microwave oven. Such cooking causes the item being cooked to retain the bowl-like shape of the two shaping members.

### CLAIM OF PRIORITY TO PRIOR APPLICATION

This application claims priority to provisional application having Ser. No. 61/403,752, entitled “Molds for Cooking Ribbed Tortilla Bowls in a Micro Wave”, having a filing date of Sep. 20, 2010, which is herein incorporated by reference in its entirety.

### CROSS REFERENCES TO RELATED APPLICATIONS

This application is related to Ser. No. 11/742,869 , entitled “Tortilla Cooking Apparatus”, having a filing date of May 1, 2007, which is herein incorporated by reference in its entirety.

### BACKGROUND

Eating and cooking tortillas, corn or flour, in their various forms be that as a taco, an enchilada, a tostada, a burrito, or any combinations of those and other forms of Mexican foods, has become extremely popular. So popular that such is no longer limited to specialty Mexican restaurants. Many non-Mexican themed fast-food establishments have also embraced the tortilla in its many forms.

Many large-chain supermarkets stock and sell various forms of tortilla shells for the home shopper. Such tortilla shells may be of the relatively fresh uncooked or partially cooked variety, pre-cooked or pre-formed variety, crisp variety, and the like. Pre-cooked and preformed may take the shape of a conventional U-shaped taco shell to a fancy bowl-shape in which to place a salad, guacamole, frijoles (beans), or any other such treats or combinations thereof.

Uncooked tortilla shells are not generally suited for most Mexican-related meals. The most well recognized means of cooking tortilla shells by a home user are by frying the soft tortilla shell in a frying pan having a suitable shortening in it. Frying for a short period of time will render the cooked shell pliable. Frying for longer periods will render the cooked shell crisp and brittle. How fried and for how long will all depend on the individual tastes of the end user. For those preferring the crisp shell over the softer shell, cooking the tortilla shells is difficult. One must cook them in the oil and shape them while cooking until the desired shaped is accomplished. All the while during this cooking process, the user must be careful to create and maintain the desired shape while cooking and not to break the tortilla shell in the process.

Many innovations in tortilla-cooking and other food cooking devices and utensils have been made over the years due in large part to the rising popularity of foods involving the use of tortilla shells. Health-conscious diets caution against frying with shortenings and oils and other unhealthy ingredients. Some have even resorted to baking the tortilla shells to their liking thereby eliminating any undesirable qualities occasioned by use of any shortening or oil. Baking, however, is more time-consuming and consumes considerable energy in the process. Cooking tortilla shells in the microwave oven makes it extremely difficult to form and generally tends to render the cooked shell soggy and unappealing. If the tortilla shell is of the flour variety, in addition, it will blister and generally deform.

The foregoing has outlined some of the more pertinent objects of a novel cooking device of the present invention. These objects should be construed to be merely illustrative of some of the more prominent features and applications of cooking devices using tortilla or other flatbread. Many other beneficial results can be attained by applying the disclosed cooking device of the present invention in a different manner or by modifying the cooking device of the present invention within the scope of the invention.

### SUMMARY

The above-noted problems, among others, are overcome by the cooking device of the present invention. In one example embodiment, the cooking assembly includes two bowls or shaping members of the same size and shape as they nest inside each other and are interchangeable. In this example embodiment, the shape of the shaping member is bowl that is circular in a connecting series of semi-circular horizontally extending uniform arches with a flat on top. The arches include tapering angular sides connecting to a wider opening at the bottom (inverted bowl), the sides are bowed out in equal sections with the curvature of the bowing being larger at the bottom which forms a series of vertical rounded ridges and “V ” shaped vertical valleys in between the ridges. Along the crest of the ridges (or corrugated rows) are apertures or vent holes in a vertical pattern. Apertures are also present across the flat surface of the top. Along the bottom edge support feet extend out in a downward direction from the crest of each bowed out ridge and in the same curvature as the ridge. In a related embodiment, the bowl mold can form bowls from other foods such as potatoes, yucca, sweet potatoes, apples and other foods that can be formed into a bowl.

None of the innovations uncovered have been as innovative as the cooking device of the present invention which, by using the microwave oven, can cook any variety of tortilla shells into the most commonly desired shapes to produce a more healthy and edible tortilla shell than previously capable. All this while preventing deformation and in the process minimizing the blistering effect as many of the flour variety are prone to do if cooked with any other cooking device in the microwave oven. The cooking device of the present invention directs microwave air flow in such a manner as to more evenly and fully cook the tortilla shell (or flatbread or pita bread or other food items) and limit blistering especially when cooking flour tortilla shells for tostada bowls. The mold for cooking tortilla shells into tostada bowls can be used with or without a base. In the various embodiments of the invention, the cooking device of the present invention is extremely easy to use, simple to manufacture, can be made in versatile shapes and can be designed to be disposable or collapsible.

In one example embodiment, the tortilla or flatbread cooking device of the present invention contemplates a cooking device for tortilla shells, or other foods, to evenly cook and shape them into bowls for salad or the like. In related embodiments, the geometric shape of the shaping member is selected from the group consisting of, but not limited to, round, oval, triangle, U-shape, V-shape, and square shapes. In one example embodiment, the cooking device includes a plurality of apertures on each of a plurality of peaks forming the corrugated walls of the shaping member the purpose of which is to allow full circulation of microwaves on the seated surface of a tortilla shell placed on each shaping member. Thereafter, with the tortilla or flatbread thereon, the cooking device is placed into a conventional microwave oven for heating and cooking with microwave energy to any desired flexibility, or crispiness causing the tortilla to retain its crisp defined shape. In a related embodiment, the construction material of the shaping member is modified to accommodate infrared radiation energy for cooking.

The foregoing has outlined the more pertinent and important features of the tortilla cooking device of the present invention in order that the detailed description that follows may be better understood so the present contributions to the art may be more fully appreciated. Additional features of the tortilla cooking device of the present invention will be described hereinafter which form the subject of the claims. It should be appreciated by those skilled in the art that the conception and the disclosed specific embodiment may be readily utilized as a basis for modifying or designing other structures and methods for carrying out the same purposes of the tortilla cooking device of the present invention. It also should be realized by those skilled in the art that such equivalent constructions and methods do not depart from the spirit and scope of the tortilla cooking device of the present invention as set forth in the appended claims.

### BRIEF DESCRIPTION OF THE DRAWINGS

For a fuller understanding of the nature and objects of the tortilla cooking device of the present invention, reference should be had to the following detailed description taken in conjunction with the accompanying drawings in which:

FIGS. 1A and 1B are top and side views of a cooking device of the invention adapted to be used for cooking and shaping tortillas and other foods into bowls.

FIG. 2 is a perspective view of a cooking device according to the invention.

FIG. 3 is a side view of a cooking device according to the invention that complements the cooking device of FIG. 1.

### DETAILED DESCRIPTION

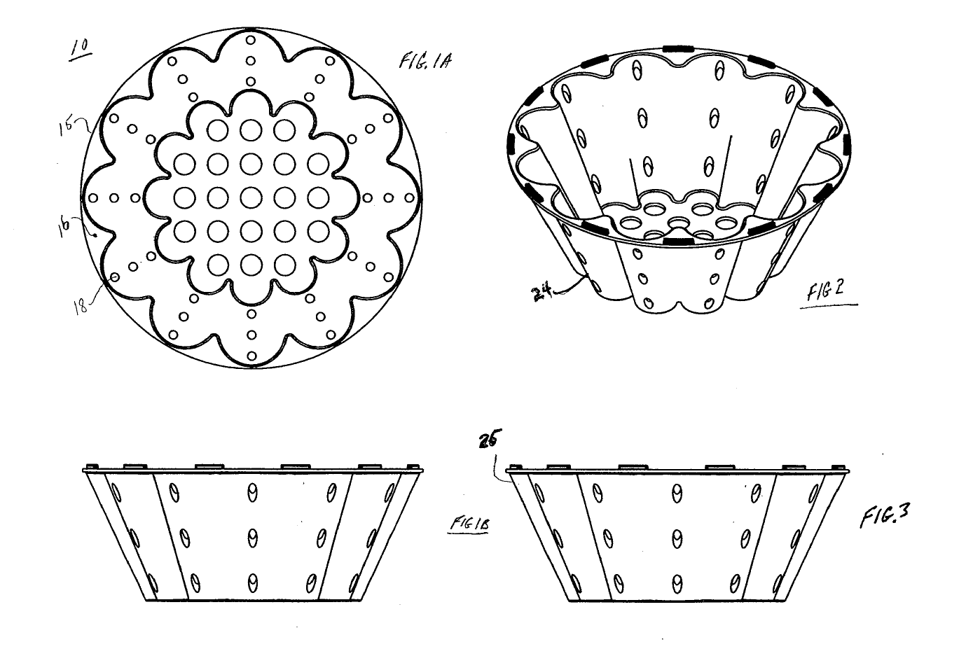

Referring now to the drawings in detail and in particular to FIGS. 1A-1 B, 2 and 3, reference character 10 generally designates an example embodiment of the cooking system of the present invention. Cooking system 10 is suited for cooking tortilla shells, and other foods, shaped into a bowl for salads and the like. It has a first shaping member 15 onto which a tortilla shell is draped and a second shaping member 25 for covering shaping member 15. With a tortilla shell therebetween, the entire shaping assembly is placed into a conventional microwave oven for cooking.

In this example embodiment, shaping member 15 is configured into a corrugated bowl. A plurality of corrugated rows 16 are formed in the inner surface of shaping member 15 and are disposed radially about symmetrically about the entire inner surface. In between rows 16 (valleys or channels) are disposed a plurality of vent holes or apertures 18. As a tortilla shell (not shown) is draped over shaping member 15 it will rest on a plurality of peaks 24 on the top of shaping member 15 opposite the valleys of shaping member 15. Once shaping member 25 is draped over shaping member 15, a flue-like structure is formed in the space defined by each row 16 and corresponding valley. Though the apertures 18 are shown to be on the peaks 24, the apertures 18 may be on the sides of the peaks 24 on in the valleys or both. The respective peaks and valleys also may be rounded, pointed, flat, or any combinations thereof. Consequently, as the tortilla shell cooks in a microwave oven, microwaves and air will vent up through the flue-like structures and through and out of the plurality of apertures 18 in the peaks 24. The plurality of apertures 18 and the flue-like structures cause the heating components of the microwaves to circulate evenly on the inside of the tortilla shell [that portion resting on and adjacent to peaks 24].

The entire inner portion of the tortilla shell is so heated and cooked to virtually even perfection to the desired state of the user [from pliable to crisp or any variation in between]. If cooked to a crisp state, the cooked tortilla shell will not only be properly and evenly cooked, but will retain the shape of shaping member 15 when removed. When the tortilla shell is then inverted, it will resemble the familiar U-shape suited for a taco and acceptance of fillings of the user's choice.

In a related embodiment, the cooking device/assembly and method taught herein cook and form foods with a high moisture content such as flat breads or pita bread, or the link, into highly uniformed ribbed bowl shapes, without using any oil fat or grease. In the method of forming a bowl, one bowl is inverted with the opening facing down and the flatbread is then centered or draped on the top of the inverted bowl at the small end. The other bowl is then placed on top of the first bowl in a nesting fashion and sandwiches the flatbread in between. As one bowl is optionally connected to the other to form a single unit or assembly, they are placed in a microwave oven and cooked. The heat of the microwave radiation causes moisture in the flatbread (or tortilla or pita bread other food) to turn to steam and is released through vent holes cooking and allowing the flatbread to fully conform to the shape of the bowls resulting in a crispy crunchy no fat edible bowl.

As the heat passes from the inside through the vent holes cooking the flatbread from both sides at once, the vertical ridges act as chimneys; as the heat rises the moisture is released as steam vapor passing through the flatbread sandwiched in between the bowls, cooking the flatbread from both sides resulting in a crispy crunchy tortilla bowl. The design of the cooking assembly prevents the blistering of tortillas, which is important when cooking bowls. A flat surface on the bottom of bowl gives it a more stable shape than bowls cooked in a conventional oven that are not formed as described herein.

In this example embodiment, the material of the cooking apparatus is slightly flexible plastic or polypropylene so as to make it easy to take apart the concentric bowls after cooking. This property allows the bowls or mold to pull away from the tortilla without damaging the crispy crunchy tortilla bowl. Cooking the flatbread or tortilla in the bowl assembly from both sides reduces the cooking time of the conventional methods substantially. Oil and grease are normally used in cooking as a lubricant, but the cooking method of the invention needs no oil grease or fat, because the steam acts as a lubricant to separate the tortilla or flatbread from the mold.

In this example embodiment, the holes on the top surface of the shaping members or molds have a uniformed pattern which allows heat building up inside the space between the inner walls of the inside and outside bowl to escape as the heat rises. After one or both bowls are removed from the oven and molds are removed, some steam is still released and the tortilla bowl becomes more crispy and crunchy. In a few minutes, the bowl is substantially uniformed with no blisters; the hot air pockets between the molds facilitate this process and stops uneven cooking.

In a related embodiment, the shaping bowl is used to form bowls for deserts, ice cream, yogurt, tarts, fruit and the like. Other foods for forming into bowls or to use with the shaping bowl or member are doughs of various kinds, and batters, such cookie batters and cake batters.

The present invention includes that contained in the present claims as well as that of the foregoing description. Although the cooking apparatus and system of the present invention has been described in its preferred forms with a certain degree of particularity, it is understood that the present invention of the preferred forms has been made only by way of example and numerous changes in the details of construction and combination and arrangement of parts and method steps may be resorted to without departing from the spirit and scope of the cooking device of the present invention.

Applicant[s] have attempted to disclose all the embodiment[s] of the tortilla cooking device of the present invention that could be reasonably foreseen. It must be understood, however, that there may be unforeseeable insubstantial modifications to tortilla cooking device of the present invention that remain as equivalents and thereby falling within the scope of the tortilla cooking device of the present invention.

What is claimed is:

1. An apparatus for use in cooking a food item in a microwave oven, the apparatus comprising:
a body having at least a width and a height, the body including alternating ridges and valleys disposed along at least a portion of the width of the body and extending transverse to the width of the body, each of the ridges and each of the valleys having two sides and a connecting portion connected to the two sides; and wherein each of the ridges provides wholly within the ridge at least one aperture configured to allow steam to pass from the food item, when disposed on the body and cooked in a microwave oven, through the at least one aperture.

2. The apparatus of claim 1 wherein the body is formed of geometric shape selected from the group consisting of round, oval, square and rectangle and triangle.

3. The apparatus of claim 1 wherein each of the ridges provides a plurality of apertures disposed along a length of the ridge and wherein each of the ridges provides the apertures along the peak of the ridge.

4. The apparatus of claim 1 wherein each of the ridges provides the apertures along the peak of the ridge.

5. The apparatus of claim 1 wherein the body consists of material selected from the group consisting of microwave-safe, disposable, infrared-safe, dishwasher safe, cardboard, paper, and wax-coated paper material.

6. The apparatus of claim 1 wherein the ridges and valleys extend linearly transverse to the length and parallel to each other

7. The apparatus of claim 1 wherein the food item is selected from the group consisting of a tortilla, flatbread, pita bread, potato, sweet potato, yucca, apple, pear.
